(19) United States
(12) Patent Application Publication
(10) Pub. No.: US 2007/0156785 A1
(43) Pub. Date: Jul. 5, 2007

(54) Method and system for revising manuals

(76) Inventors: Wallis G. Hines III, Hudson, WI (US); Deborah Hines, Hudson, WI (US); Ronald B. Payne, Victoria, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/649,339

(22) Filed: Jan. 3, 2007

Related U.S. Application Data
(60) Provisional application No. 60/755,936, filed on Jan. 3, 2006.

(51) Int. Cl. G06F 17/30

(52) U.S. Cl. 707/203

(57) ABSTRACT

A method of revising a manual including opening a revision time period for the manual, iteratively revising the manual based on one or more change requests, closing the revision time period, and publishing a revised manual based on the one or more change requests. Iteratively revising the manual includes submitting a change request for the manual using an electronic revision management system, producing a first draft of the change request, approving the first draft of the change request using the electronic revision management system, receiving feedback on the change request from one or more reviewers through the electronic revision management system, revising the change request as necessary using the electronic revision management system based on the feedback received from the reviewers, producing a final draft of the change request, and approving the final draft of the change request using the electronic revision management system.

### CROSS-REFERENCE TO RELATED APPLICATION(S)

This application claims priority to and incorporates herein by reference U.S. Provisional Application Ser. No. 60/755,936, filed Jan. 3, 2006 and entitled “Revision Manager.”

### BACKGROUND

The present invention relates to methods and systems for revising manuals.

Document revision management systems are well known in the art. However, prior systems often utilize a “software only” approach to solve the manual revision problem. Such systems have several disadvantages. Prior systems often require a medium to high level of computer expertise to use the system. The level of expertise necessary makes user training expensive and time consuming. Additionally, prior systems often require a high up front and/or ongoing capital investment. Prior systems incorporating a “software only” approach provide no support for the manual revision process—only support for the software tool used in the process. Some prior systems do not facilitate communication between company employees working on a manual revision or company employees and third party reviewers, such as regulatory overseers, and require internal corporate Information Systems (IS)/Information Technology (IT) support for their installation and use. Most notably, however, prior systems have failed to blend human resources and electronic systems automation to provide a reliable, repeatable, and cost effective method of revising manuals.

### SUMMARY

A method of revising a manual including opening a revision time period for the manual, iteratively revising the manual based on one or more change requests, closing the revision time period, and publishing a revised manual based on the one or more change requests. Iteratively revising the manual includes submitting a change request for the manual using an electronic revision management system, producing a first draft of the change request, approving the first draft of the change request using the electronic revision management system, receiving feedback on the change request from one or more reviewers through the electronic revision management system, revising the change request as necessary using the electronic revision management system based on the feedback received from the reviewers, producing a final draft of the change request, and approving the final draft of the change request using the electronic revision management system.

### BRIEF DESCRIPTION OF THE DRAWINGS

FIG. 1 is a flow diagram illustrating a method of revising a manual.

FIG. 2 is a block diagram illustrating the architecture of system 32 used for revising manuals according to the method illustrated in FIG. 1.

FIGS. 3-12 are captured displays illustrating user interaction with an electronic revision management system illustrated in FIG. 2.

### DETAILED DESCRIPTION

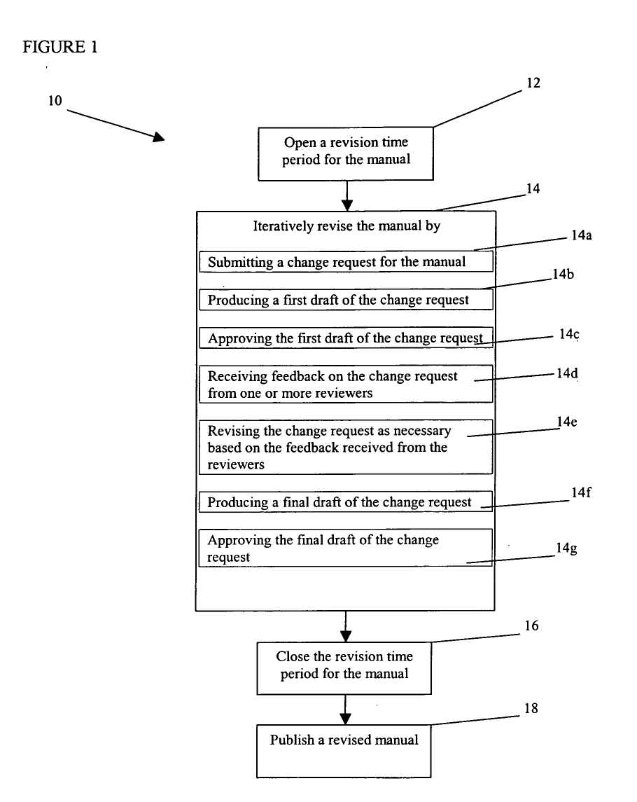

FIG. 1 is a flow diagram illustrating a method 10 of revising a manual. Method 10 includes opening a revision time period for the manual (step 12), iteratively revising the manual based on one or more change requests (step 14), closing the revision time period for the manual (step 16), and publishing a revised manual (step 18). Iteratively revising the manual (step 14) includes submitting a change request for the manual (step 14a), producing a first draft of the change request (step 14b), approving the first draft of the change request (step 14c), receiving feedback from one or more reviewers (step 14d), revising the change request as necessary based on the feedback (step 14e), producing a final draft of the change request (step 14f), and approving the final draft of the change request (step 14g).

The method 10 of revising a manual begins by opening a revision time period for the manual (step 12). Opening a revision time period for the manual may be accomplished in a variety of ways. For example, manuals that require periodic maintenance may have a set revision schedule, for example every three months, which automatically opens throughout a given year.

After the revision time period is opened, the manual is iteratively revised based on one or more change requests (step 14). Iteratively revising the manual (step 14) includes submitting a change request for the manual (step 14a), producing a first draft of the change request (step 14b), approving the first draft of the change request (step 14c), receiving feedback from one or more reviewers (step 14d), revising the change request as necessary based on the feedback (step 14e), producing a final draft of the change request (step 14f), and approving the final draft of the change request (step 14g). Steps 14a-14g are repeated as necessary throughout the revision time period to produce a revised manual, which is then published.

Submitting a change request (CR) for the manual (step 14a) may be accomplished using an electronic revision management system and include accessing the revision management system by logging into an application running in a web browser, reviewing one or more comments on the manual submitted by users of the manual, and submitting a CR for the manual. Components of the revision management system may be accessed over a wired or wireless network connection through a standard web browser, such as Internet Explorer, Netscape Navigator, or Mozilla's Firefox. Authors may submit CRs by logging into the system and electronically inputting the location of the change in the manual, the content of the change, as well as requesting feedback from one or more reviewers of the CR. Authors may also consider comments on the manual submitted by end users of the manual when submitting CR. For example, a manual for aircraft engine repair may include comments from aircraft mechanics regarding the clarity of one or more sections detailing repair procedures. Users of the manual may access the revision management system to view manuals and submit comments. After the users have submitted comments, the system automatically makes the comments available to authors responsible for revising the manual.

After submitting the CR for the manual (step 14a), a first draft of the CR is produced (step 14b). Producing the first draft of the CR includes receiving the CR through the electronic revision management system, revising the manual based on the CR to produce the first draft of the CR, and importing an electronic copy of the first draft of the CR into the system. A person responsible for managing the manual revision process, for example a revision manager, is alerted when authors of the manual submit CRs. For example, the revision management system automatically e-mails the revision manager the CRs submitted by the authors. Alternatively, the system may include a component for revision managers that, when accessed, automatically displays any CRs submitted by authors and pending incorporation into a first draft. After the revision manager has received the CR, the change is incorporated into the manual at the location indicated in the CR. Finally, the revision manager imports an electronic copy of the first draft of the CR into the revision management system. Importing a copy of the first draft of the CR into the system may include, for example, electronically importing the copy into a database that makes the draft available to authorized users, such as authors. Alternatively, importing a copy of the first draft of the CR may include saving the draft in a file format and location, which makes the draft available to authors through the revision management system. In this alternative example, the revision manager could save the first draft of the CR in a PDF format on a secure network drive that is accessible by authors using the revision management system.

After producing a first draft of the CR (step 14b), the first draft is approved (step 14c). Approving the first draft of the CR may be accomplished by the authors reviewing and then approving the first draft of the CR in the revision management system to ensure that the change has been correctly incorporated into the manual.

After approving the first draft of the CR (step 14c), the authors receive feedback from the reviewers (step 14d). Receiving feedback from reviewers includes electronically alerting reviewers of the request for feedback, accessing the revision management system by logging into an application running in a web browser, reviewing the CR, and submitting feedback on the CR using the electronic revision management system. Reviewers of the CR may be alerted of the request for feedback automatically by the revision management system at the time the authors submit the CR. For example, the system includes a component for reviewers that, when accessed, automatically displays any CR for which the authors requested feedback by the reviewers. In this example, the reviewers access the system through a web browser and review the CR for which authors have requested feedback. The system displays the CR location, content, and only the feedback submitted by the reviewer logged into the system. After reviewing the CR, the reviewers submit feedback using the revision management system. The system automatically alerts the authors that the feedback has been submitted, for example by sending an e-mail or by displaying the feedback in components of the system accessed by the authors. Authors viewing CRs through the revision management system may view feedback from all reviewers reviewing a particular CR.

After receiving feedback from the reviewers (step 14d), the authors may revise the CR (step 14e) as necessary based on the feedback. Revising the CR may be accomplished in substantially the same way as submitting the CR (step 14a), including accessing the revision management system, reviewing the feedback received from the reviewers, and submitting revisions to the CR based on the feedback received from the reviewers.

After the authors revise the CR, a final draft of the CR is produced (step 14f). Producing the final draft of the CR may be accomplished in substantially the same way as producing the first draft of the CR (step 14b), including receiving the revised CR through the revision management system, revising the manual based on the revised CR to produce the final draft of the CR, and importing an electronic copy of the final draft of the CR into the electronic revision management system.

After producing the final draft of the CR (step 14f), the final draft is approved (step 14g). Approving the final draft may be accomplished, in part, in substantially the same way as approving the first draft of the CR (step 14c), including accessing the revision management system, reviewing an electronic copy of the final draft of the CR, and approving the final draft of the CR by communicating the approval through the electronic management system. The final draft may be approved by the authors and also, in appropriate cases, third party approvers. For example, manuals produced for the aircraft industry may require regulatory approval by the Federal Aviation Administration (FAA). In this example, the final draft may require approval by an FAA overseer. The FAA overseer, in a similar manner to other users, may access the revision management system to review and approve the final draft of the CR. The FAA overseer, or other third party approver, may initially reject the final draft of the CR, in which case approving the final draft of the CR will necessitate one or more intermediate drafts before the FAA overseer submits their approval. In such cases, the authors may revise the CR as necessary to accommodate rejections from the FAA overseer. Additionally, approving the final draft of the CR (step 14g) may include resolving conflicts as necessary with one or more other manuals whose content is affected by the CR included in the final draft. In some cases changes to one manual may affect the content of one or more other manuals. For example, changes to the content of an aircraft repair procedure in a repair manual may affect the content of a pilot's manual including an engine maintenance checklist. In such circumstances, approving the final draft of the CR may require resolving conflicts with other manuals. Resolving conflicts may be accomplished, for example, by requiring approval of the final draft of the CR by the authors of all the affected manuals, including the manual being revised and the manuals whose content may be affected by the revision. Steps 14a-14g are repeated iteratively throughout the revision time period to revise the manual based on the change requests submitted by authors.

After iteratively revising the manual based on one or more change requests (step 14), the revision time period is closed (step 16). Methods of revising a manual according to the present invention may also include extending the revision time period. However, extending the revision time period preferably includes providing a reason for the time extension. For example, authors may request additional time to submit or approve CRs or FAA oversight may necessitate extending the revision time period due to delays in approval by regulatory overseers. In such circumstances, the revision time period is preferably extended only after a reason is provided for the extension and the reason is archived in the revision management system for tracking and reference purposes. Closing the revision time period, with or without extensions, includes manually checking, for example through a meeting between the revision manager and the authors, that the revision method steps have been complied with to arrive at a revised manual. For example, the revision manager may meet with the authors to check that CRs have been submitted and reviewed as necessary, feedback has been received and considered, the manual has been revised based on the CRs, and the drafts of the CRs have been approved by the authors and the necessary third party approvers. After closing the revision time period (step 16), a revised manual is published (step 18), for example, by importing a copy of the revised manual into the revision management system or printing copies of the revised manual and distributing the copies to the owners and users of the manual.

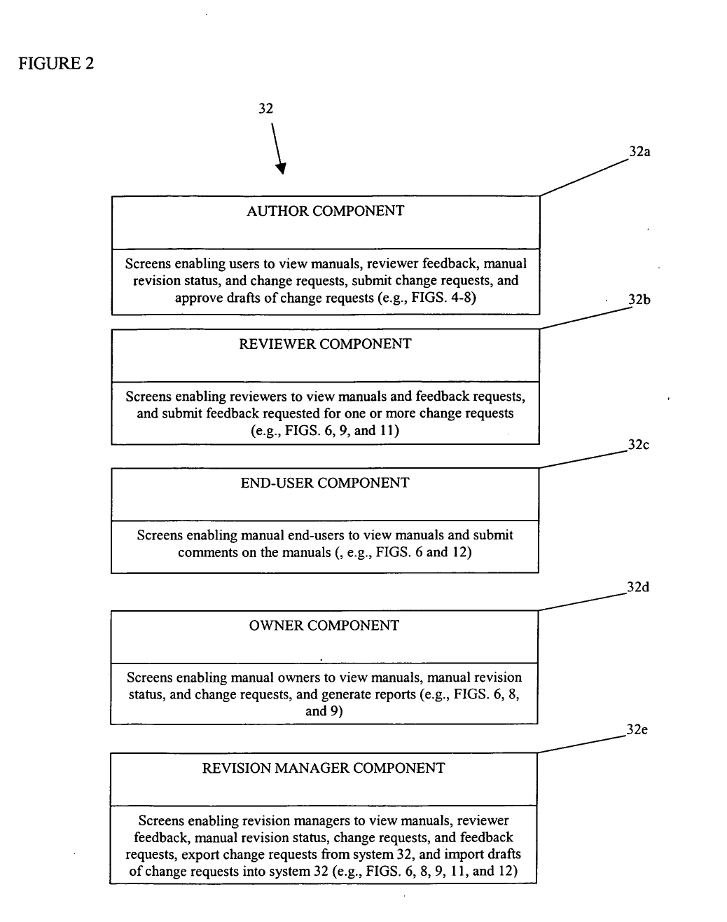

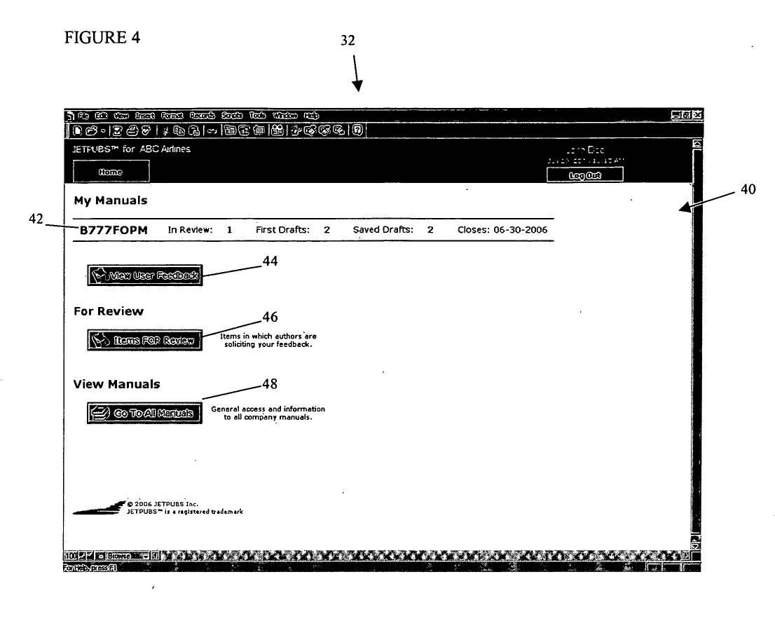

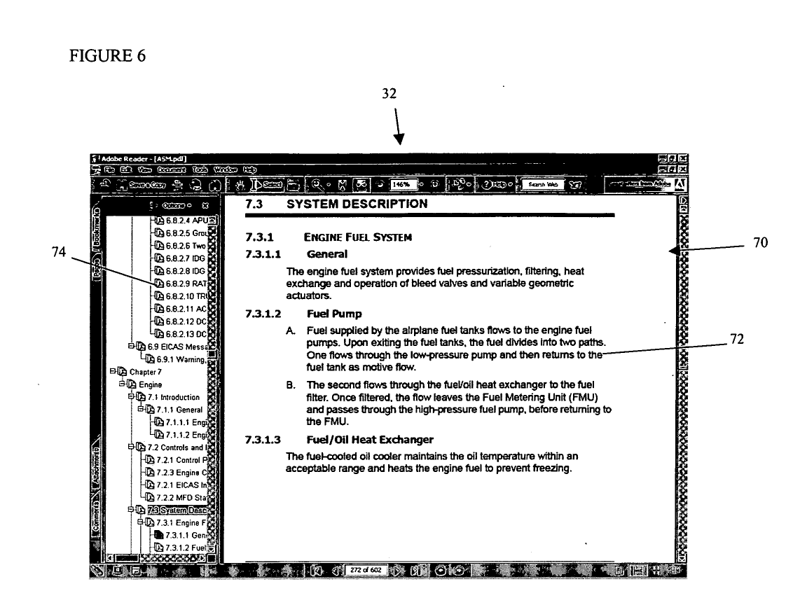

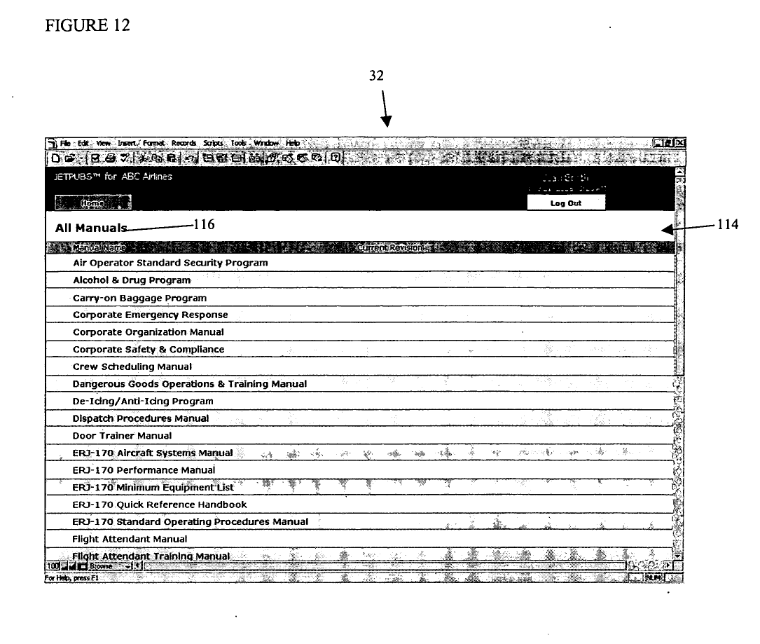

FIG. 2 is a block diagram illustrating the architecture of system 32 used for revising manuals according to the method illustrated in FIG. 1. System 32 includes author component 32a, reviewer component 32b, end-user component 32c, owner component 32d, and revision manager component 32e. Author component 32a includes screens enabling users to, for example, view manuals, reviewer feedback, manual revision status, and change requests, submit change requests, and approve drafts of CRs (see, e.g., FIGS. 4-8). Reviewer component 32b includes screens enabling reviewers to view manuals and feedback requests, and submit feedback requested for one or more change requests (see, e.g., FIGS. 6, 9, and 11). End-user component 32c includes screens enabling manual end-users to view manuals and submit comments on the manuals (see, e.g., FIGS. 6 and 12). Owner component 32d includes screens enabling manual owners to view manuals, manual revision status, and change requests, and generate reports (see, e.g., FIGS. 6, 8, and 9). Revision manager component 32e includes screens enabling revision managers to view manuals, reviewer feedback, manual revision status, change requests, and feedback requests, export change requests from system 32, and import drafts of CRs into system 32 (see, e.g., FIGS. 6, 8, 9, 11, and 12).

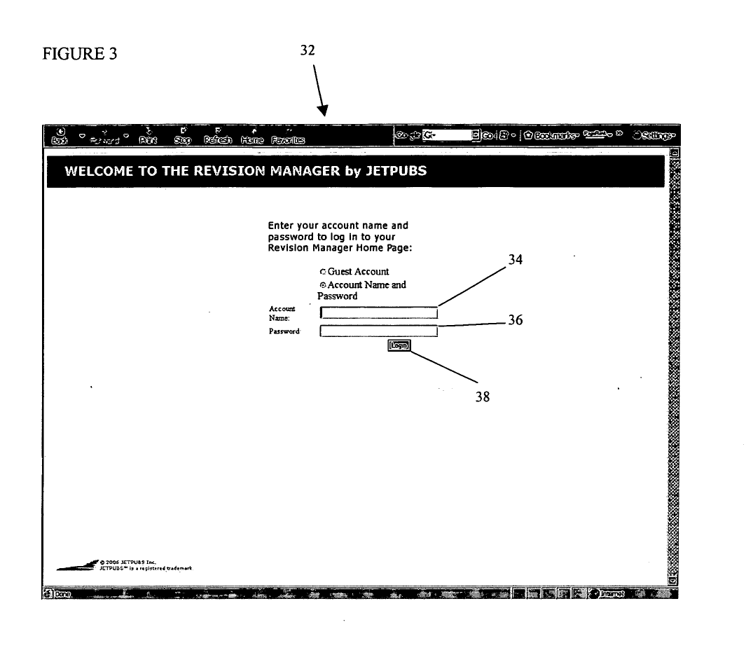

FIGS. 3-11 are captured displays illustrating user interaction with electronic revision management system 32 illustrated in FIG. 2. In FIG. 3, a user accesses system 32 by entering an account name in box 34, a password in box 36, and clicking login button 38. System 32 may be stored and processed locally on a single computer, or may be distributed across a communications network with components of the system stored and processed on a server and other components stored and processed on a client. The system may be accessed locally or remotely over a wired or wireless network connection. Software programs used in the system or used to access the system may include one or more software applications, programming languages, and technologies and interact with off-the-shelf or proprietary relational databases or other data storage and retrieval mechanisms. In FIG. 3, for example, the user accesses system 32 over a secure Internet connection using a web browser, such as Internet Explorer, Netscape Navigator, or Mozilla's Firefox.

Users of system 32 may include manual authors, reviewers, owners, and end-users. Persons responsible for managing the manual revision process, such as revision managers, may also use system 32. Additionally, third party approvers, such as regulatory overseers may use system 32. Authors may be the primary users of system 32. Authors use system 32, for example, to submit change requests (CRs) to the manuals for which they are directly responsible. As authors submit CRs, they can solicit feedback from other individuals regarding their requests. Additionally, when CRs are submitted that directly impact another manuals, system 32 may be configured to require reconciling differences between the manual being changed and the other manuals impacted by the change. In this way, system 32 may be configured to substantially enforce content standardization across multiple manuals and departments. Additionally, system 32 may be configured to archive all communication concerning a particular CR for future reference. Archiving allows for regulatory review and compliance as well as charting the evolution of particular manual sections.

Reviewers provide feedback on CRs, as requested by the authors. In addition, reviewers may submit unsolicited feedback to authors as necessary. Manual owners may use system 32 to track manual revision status and to substantially ensure efficient utilization of internal resources. For example, owners may use system 32 to generate customized reports regarding one or more manual revisions. Reports generated using system 32 may include, for example, revision status lists for manuals open for revision, percentages of manual revision time periods closed on time in a given year or quarter, percentages of the total number of manual revisions requiring time period extensions, or author scores based on successfully closing manual revisions on time. Regulatory agencies may use system 32 to review and evaluate CRs submitted by the authors. Because of the unique way system 32 processes CRs, it allows the regulatory agencies to spread their workflow over a more manageable and efficient timeframe. Prior manual revision systems and methods often force regulatory agencies to process all individual CRs at one time for each manual revision.

System 32 customizes user access according to the unique account name and password, in other words user credentials, provided. For example, in FIG. 3, an author enters an account name and password in boxes 34, 36 and clicks login 38. System 32 automatically opens author home page 40 illustrated in FIG. 4, which includes link 42 and buttons 44, 46, and 48. Link 42 provides access to one of the author's manuals open for revision. Button 44 provides the author access to comments submitted by manual end-users, button 46 provides access to CR reviews requested of the author by other authors, and button 48 provides access to a list for viewing all the manuals in system 32. In FIG. 4, the author has one manual open for revision (or is only the author of one manual) listed in “My Manuals” and accesses the manual by clicking link 42.

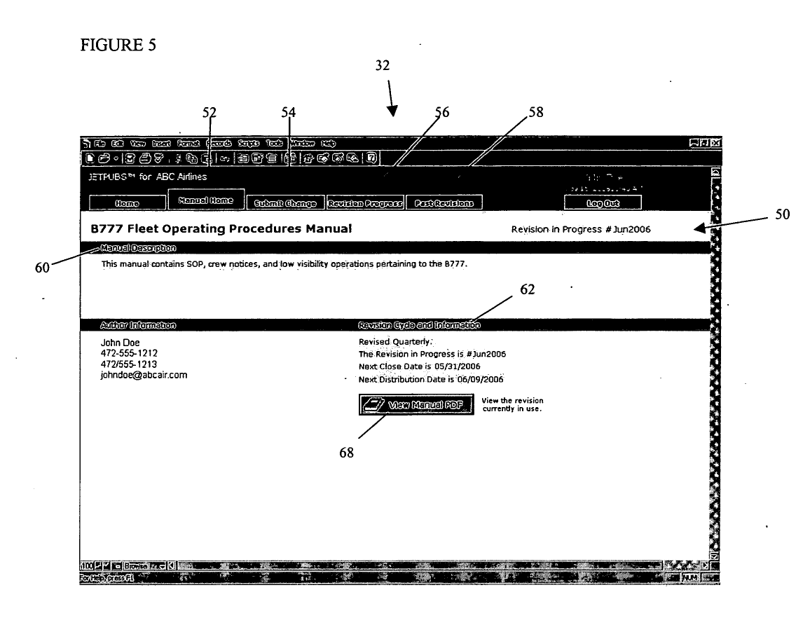

Clicking link 42 on author home page 40 opens manual home page 50 illustrated in FIG. 5, which includes menu tabs 52-58, manual description 60, revision information 62, and View Manual button 68. Menu tab 52 provides access to manual home page 50. Menu tab 54 provides access to a page for submitting change requests. Menu tab 56 provides access to a page for viewing the revision progress of CRs submitted for the manual. Menu tab 58 provides access to a page for viewing past revisions to the manual. Manual home page 50 also displays a brief textual manual description 60 and revision information 62, including for example, how often the manual is revised, the scheduled close to the revision time period, and the next scheduled manual distribution date. View Manual button 68 provides access to an electronic copy of the revision of the manual currently in use. Manual home page 50 may be configured such that end users and reviewers have access to an additional Leave Feedback button (not shown). This button allows non-authors to submit unsolicited comments and feedback for the author on one or more manuals. In FIG. 5, the author clicks View Manual button 68 to view a full copy of the manual revision currently in use.

After the author clicks button 68 in FIG. 5, system 32 opens view manual page 70 illustrated in FIG. 6. View manual page 70 provides access to a full copy of the manual, for example, an electronic PDF copy of the manual, which includes content 72 and table of contents 74. System 32 may be configured to launch view manual page 70 in a separate window. Therefore, the author can return to manual home page 50 in FIG. 5 by closing view manual page 70 shown in FIG. 6. System 32 may be configured to make view manual page 70 accessible to multiple classes of users, for example, authors, reviewers, owners, and end-users.

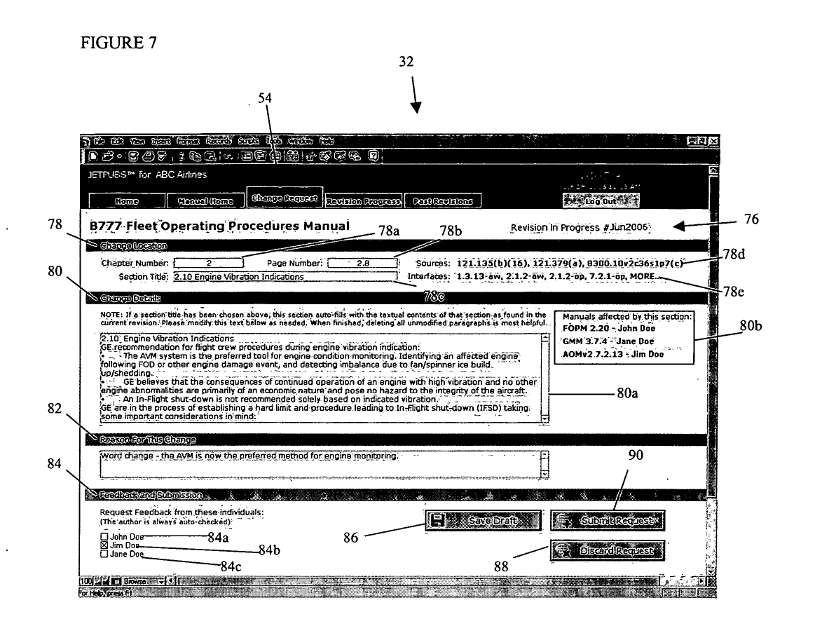

In FIG. 7, the author clicks tab 54 to access Submit CR page 76, which includes change location 78, change content 80, change reason 82, feedback requests 84, and buttons 86-90. Submit CR page 76 allows the author to submit changes for a specific manual. In FIG. 7, the author inputs change location 78 by entering, for example, a chapter number in box 78a, page number in box 78b, and section title in box 78c. System 32 may be configured to automatically display regulatory rules 78d and section cross references 78e in the manual to which the change is being requested, which drive the content of the manual section indicated by change location 78 input by the author. After inputting change location 78, the author inputs change content 80 in text box 80a. System 32 may be configured to automatically populate text box 80a with the content of the current manual revision based on change location 78 entered by the author. The author may then selectively change the content of the manual section by, for example, typing in text box 80a. Additionally, system 32 may be configured to automatically display other manuals impacted by changes at change location 78. For example, in FIG. 7, manual cross-references 80b are automatically displayed by system 32 on page 76 based on change location 78 input by the author. The author also enters a reason for the CR being submitted in box 82a under change reason 82. After inputting change location 78, change content 80, and change reason 82, the author may request reviews from one or more reviewers by clicking check boxes 84a, 84b, or 84c under feedback requests 84. At any point during the CR submission process, the author may save a draft CR by clicking button 86 or discard the CR by clicking button 88. After the author is finished entering the necessary information, including change location 78, change content 80, change reason 82, and feedback requests 84, the author submits the CR by clicking button 90. After the author submits the CR, system 32 may be configured to automatically store the CR submission and alert the revision manager to the CR submission. CRs may be stored, for example, in a database or in a file on a secure network hard drive for access through system 32. Alerting the revision manager may include, for example, e-mails sent automatically to the revision manager by system 32.

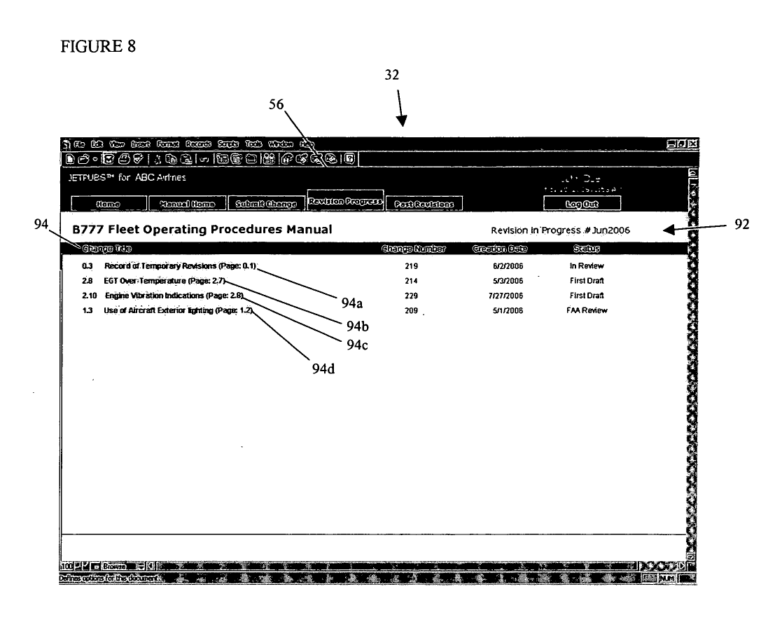

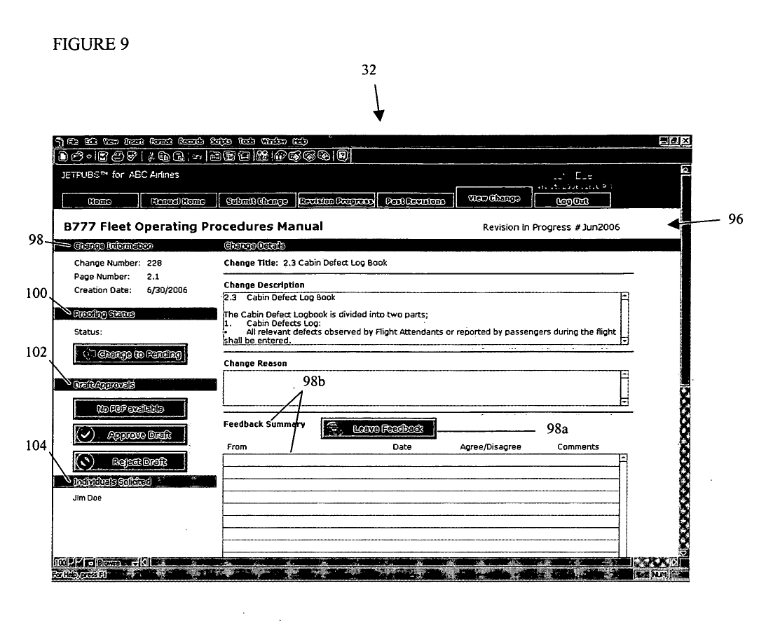

After submitting the CR, the author clicks tab 56 to access revision progress page 92 illustrated in FIG. 8, which includes CR list 94 and CRs 94a-94d. Revision progress page 92 provides the author a summary view of all the CRs in progress for the manual. CR list 94 may be sorted by “Status” so that CRs (94a-94d) furthest along in the revision process are located at the bottom of the list. The authors may use revision progress page 92 to see what items have been submitted thus far and to quickly see which items require further attention. In FIG. 8, the author views CRs 94a-94d in CR list 94 and opens a page for viewing CRs by clicking the title of one of CRs 94a-94d. Clicking the title of one of CRs 94a-94d opens view CR page 96 illustrated in FIG. 9, which includes CR information and details 98, CR status 100, approvals 102, and reviewers 104. View CR page 96 is also displayed for each reviewer asked to submit feedback for a particular CR. Additionally, view CR page 96 functionality is customized based on the class of user logged into system 32. For example, reviewers accessing page 96 will only have access to viewing CR information and details 98 and leave feedback button 98a. In addition to displaying CR information and details 98 and status 100, approvals 102 allows the author to view a PDF of the requested change as it will appear when the manual is published. At this time, the author can either approve or reject the PDF with comments. By receiving a draft of the CR a short time after submitting the initial CR, the author is better able to sign off on the request and then pass it on, for example, to a regulatory agency for their approval. CR information and details 98 includes feedback summary 98b. Feedback summary 98b displays all the feedback submitted by reviewers of the CR. Authors can view all entries in the feedback summary 98b, including, for example, reviewer feedback, regulatory overseer feedback, and feedback from the revision manager where appropriate. When reviewers and regulatory overseers view this same page, only communications between the author and the reviewer or overseer is displayed. System 32 may be configured to archive all of the information surrounding a particular CR. As discussed above, this means that if the reason for a change is ever in doubt, the author can access the reason for the change as well as all internal and regulatory communications related to the change.

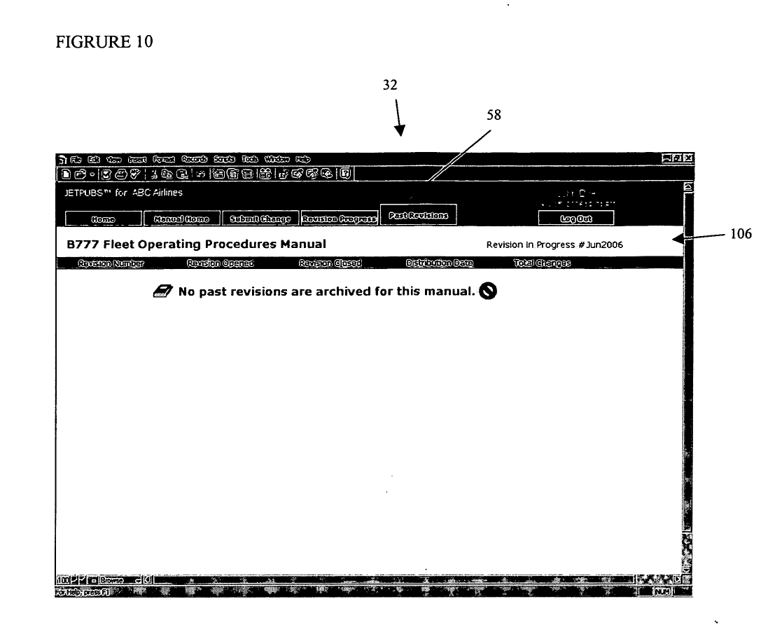

In addition to submitting and viewing CRs and approving drafts of the manual revised based on the CRs, authors can view past revisions to the manual. In FIG. 10, the author clicks tab 58 to access the past revisions page 106. Past revisions of the manual are listed on and may be reviewed from page 106. In the case the manual has no past revisions, as in the example shown in FIG. 10, page 106 notifies the author that no past revisions are archived for the manual.

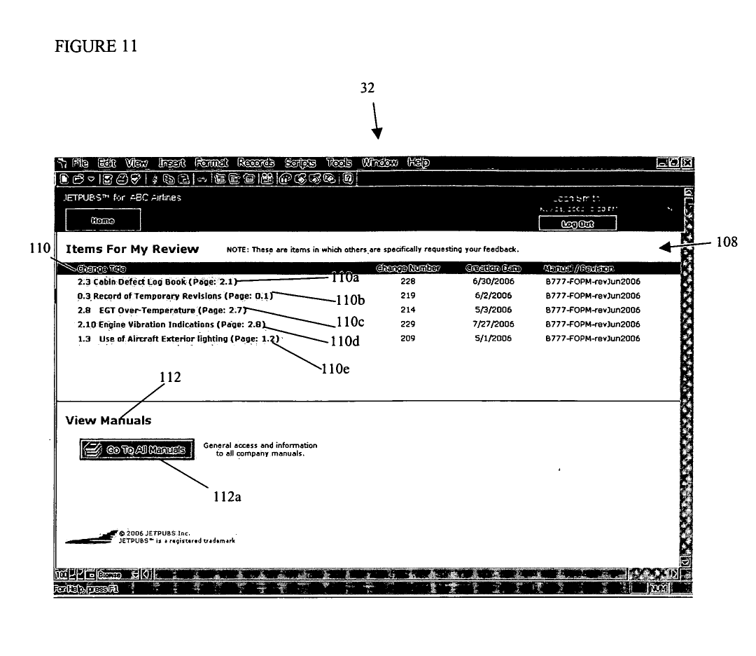

FIGS. 11 and 12 show the home pages for manual reviewers and end-users respectively. In FIG. 11, a reviewer has logged into system 32 (see FIG. 3) and is automatically presented with reviewer home page 108, which includes requested reviews 110 and view manuals 112. As illustrated in FIG. 11, system 32 may be configured to customize functionality based on user credentials. In FIG. 11, reviewers have access to a smaller portion of system 32 than, for example, authors. System 32 automatically populates requested reviews 110 with all of the CRs the reviewer has been requested to review. Clicking the title of one of CRs 110a-110e opens view CR page 96 shown in FIG. 9 from which the reviewer may view the CR and leave feedback for the author. Clicking view manuals button 112a opens the view all manuals page 114 shown in FIG. 12, which includes all manuals list 116. View all manuals page 114 is also the home page for end-users. Users of system 32, including authors, reviewers, owners, and end-users, may view the full content of manuals by clicking one of the manual titles in all manuals list 116. For example, the reviewer clicks on of the titles in all manuals list 116 and system 32 opens a PDF copy of the manual in another window (see, e.g., FIG. 6).

Methods and systems according to the present invention have several advantages over prior methods of and systems for revising manuals. For example, users involved in the manual revision process need little to no previous computer experience. Because the methods and systems according to the present invention are focused on the manual revision process and not the technology facilitating the process, training new users takes much less time than prior systems and is therefore less costly. Employing methods and systems according to the present invention is comparatively less costly than prior complex document revision management systems requiring high up front and/or ongoing capital investment. Revision managers responsible for managing the manual revision process provide support for questions related to the manuals, not just questions related to the electronic revision management system. In appropriate cases, revision managers may suggest changes or corrections when processing CRs. Embodiments of the present invention allow for quick, easy, and archived communication between employees (authors, reviewers, owners, end-users) and the regulatory agencies (as appropriate). Systems according to the present invention require little to no installation and internal IS/IT support. Revision managers may also physically management manual files, manual revision archiving, and manual distribution, relieving the company entirely of these responsibilities. Methods and systems according to the present invention blend human resources and electronic systems automation to produce a reliable, repeatable, and cost effective means for revising manuals.

Although the present invention has been described with reference to preferred embodiments, workers skilled in the art will recognize that changes may be made in form and detail without departing from the spirit and scope of the invention.

1. A method of revising a manual, the method comprising:
opening a revision time period for the manual;
iteratively revising the manual based on one or more change requests,
wherein iteratively revising the manual includes
submitting a change request for the manual using an electronic revision management system,
producing a first draft of the change request,
approving the first draft of the change request using the electronic revision management system,
receiving feedback on the change request from one or more reviewers through the electronic revision management system,
revising the change request as necessary using the electronic revision management system based on the feedback received from the reviewers,
producing a final draft of the change request, and
approving the final draft of the change request using the electronic revision management system;
closing the revision time period; and
publishing a revised manual, wherein the revised manual is based on the one or more change requests.

2. The method according to claim 1 further comprising:
extending the revision time period, wherein extending the revision time period includes providing a reason for extending the revision time period.

3. The method according to claim 1, wherein submitting a change request for the manual using an electronic revision management system further comprises:
accessing the electronic revision management system by logging into an application running in a web browser;
reviewing one or more comments on the manual submitted in the electronic revision management system by users of the manual; and
submitting the change request for the manual, wherein the change request includes a change location, change content, reason for the change request, and one or more requests for feedback from one or more reviewers.

4. The method according to claim 3, wherein the application running in the web browser is adapted to be accessed remotely over a network connection.

5. The method according to claim 1, wherein producing the first draft of the change request further comprises:
receiving the change request through the electronic revision management system;
revising the manual based on the change request to produce the first draft of the change request; and
importing an electronic copy of the first draft of the change request into the electronic revision management system.

6. The method according to claim 1, wherein approving the first draft of the change request using the electronic revision management system further comprises:
accessing the electronic revision management system by logging into an application running in a web browser;
reviewing an electronic copy of the first draft of the change request; and
approving the first draft of the change request by communicating the approval through the electronic management system.

7. The method according to claim 6, wherein the electronic revision management system is adapted to be accessed remotely over a network connection.

8. The method according to claim 1, wherein receiving feedback on the change request from one or more reviewers through the electronic revision management system further comprises:
electronically alerting reviewers of the request for feedback;
accessing the electronic revision management system by logging into an application running in a web browser;
reviewing the change request; and
submitting feedback on the change request using the electronic revision management system.

9. The method according to claim 8, wherein the electronic revision management system is adapted to be accessed remotely over a network connection.

10. The method according to claim 1, wherein revising the change request as necessary using the electronic revision management system based on the feedback received from the reviewers further comprises:
accessing the electronic revision management system by logging into an application running in a web browser;
reviewing the feedback received from the reviewers; and
submitting revisions to the change request as necessary using the electronic revision management system based on the feedback received from the reviewers.

11. The method according to claim 10, wherein the electronic revision management system is adapted to be accessed remotely over a network connection.

12. The method according to claim 1, wherein producing the final draft of the change request further comprises:
receiving the revised change request through the electronic revision management system;
revising the manual based on the revised change request to produce the final draft of the change request; and
importing an electronic copy of the final draft of the change request into the electronic revision management system.

13. The method according to claim 1, wherein approving the final draft of the change request using the electronic revision management system further comprises:
accessing the electronic revision management system by logging into an application running in a web browser;
reviewing an electronic copy of the final draft of the change request; and
approving the final draft of the change request by communicating the approval through the electronic management system.

14. The method according to claim 13, wherein the electronic revision management system is adapted to be accessed remotely over a network connection.

15. The method according to claim 1, wherein approving the final draft of the change request further comprises resolving conflicts as necessary with one or more other manuals whose content is affected by the change request.

16. The method of claim 1, wherein closing the revision time period further comprises substantially ensuring that the change request has been submitted and reviewed as necessary, the feedback has been received and considered, the manual has been revised based on the change request, and the drafts of the change request have been approved.

17. The method of claim 1, wherein publishing the revised manual further comprises making the revised manual available to the owners and users of the manual.

18. The method of claim 17, wherein making the revised manual available to the owners and users of the manual further comprises importing an electronic copy of the revised manual into the electronic revision management system.

19. The method of claim 17, wherein making the revised manual available to the owners and users of the manual further comprises printing copies of the manual and distributing the printed copies to the owners and users of the manual.

20. An electronic revision management system for revising manuals, the system comprising:
an author component for viewing manuals, reviewer feedback, manual revision status, and change requests, submitting one or more change requests, and approving one or more drafts of the change requests.
a reviewer component for viewing manuals and feedback requests, and submitting feedback requested for one or more change requests;
a user component for viewing manuals and submitting comments on the manuals;
an owner component for viewing manuals, manual revision status, and change requests, and generating reports; and
a revision manager component for viewing manuals, reviewer feedback, manual revision status, change requests, and requested reviews, exporting change requests, and importing drafts of change requests.

21. The system of claim 20, wherein the author component further comprises:
one or more screens for viewing one or more manuals open for revision;
one or more screens for viewing status of the manuals open for revision;
one or more screens for viewing change requests; and
one or more screens for submitting change requests.

22. The system of claim 21, wherein the screens for viewing change requests further comprise:
a display of the change request locations;
a display of the change request content;
a display of feedback from one or more reviewers;
one or more software functions for viewing the drafts of change requests; and
one or more software functions for approving the drafts of the change requests.

23. The system of claim 21, wherein the screens for submitting change requests further comprise:
a display of one or more manuals that will be affected by the change requests;
one or more software functions for inputting change request locations;
one or more software functions for inputting change request content;
one or more software functions for inputting reasons for the change requests;
one or more software functions for saving the change requests;
one or more software functions for discarding the change requests;
one or more software functions for requesting feedback on the change requests by one or more reviewers; and
one or more software functions for submitting the change requests.

24. The system of claim 20, wherein the reviewer component further comprises:
one or more screens for viewing one or more manuals open for revision;
one or more screens for viewing requests for feedback on one or more change requests; and
one or more screens for submitting feedback on the change requests.

25. The system of claim 24, wherein the screens for submitting feedback on the change requests further comprise:
a display of the change request locations;
a display of the change request content;
a display of feedback from one reviewer, wherein the one reviewer is the reviewer currently logged into the system; and
one or more software functions for submitting feedback on the change requests.

26. The system of claim 20, wherein the user component further comprises:
one or more screens for viewing one or more manuals; and
one or more screens for submitting comments on the manuals.

27. The system of claim 20, wherein the owner component further comprises:
one or more screens for viewing one or more manuals open for revision;
one or more screens for viewing status of the manuals open for revision;
one or more screens for viewing change requests; and
one or more screens for generating one or more reports.

28. The system of claim 27, wherein the screens for viewing change requests further comprise:
a display of the change request locations;
a display of the change request content;
a display of feedback from one or more reviewers; and
one or more software functions for viewing the drafts of the change requests.

29. The system of claim 20, wherein the revision manager component further comprises:
one or more screens for viewing one or more manuals open for revision;
one or more screens for viewing requests for feedback on the one or more change requests;
one or more screens for viewing status of the manuals open for revision;
one or more screens for viewing the change requests one or more screens for exporting change requests from the electronic revision management system; and
one or more screens for importing one or more drafts of the change requests into the electronic revision management system.
